(19) United States
(12) Patent Application Publication
(10) Pub. No.: US 2026/0061758 A1
(43) Pub. Date: Mar. 5, 2026

(54) PRESSURE-ASSISTED DRYING FOR AN INK JET PRINTER

(71) Applicant: Xerox Corporation, Norwalk, CT (US)

(72) Inventors: Robert E. Rosdahl, Jr., Ontario, NY (US); Derek A. Bryl, Churchville, NY (US); Dara N. Lubin, Pittsford, NY (US); Matthew J. Ochs, Webster, NY (US); Ron Edward Dufort, Rochester, NY (US); Richard P. Ficarra, Williamson, NY (US); Elizabeth M. Crossen, Churchville, NY (US); Christine A. Steurrys, Williamson, NY (US); Elizabeth L. Barrese, Penfield, NY (US); Robert R. Reed, West Henrietta, NY (US)

(73) Assignee: Xerox Corporation, Norwalk, CT (US)

(21) Appl. No.: 18/815,927

(22) Filed: Aug. 27, 2024

(51) Int. Cl. B41J 11/00; B41J 2/21

(52) U.S. Cl. CPC B41J 11/00222; B41J 2/2114; B41J 11/00242

(57) ABSTRACT

A printing system and a method of printing are described. The printing system includes a source of print media, an inkjet marking device which applies ink images to the print media, and a dryer component which receives print media from the inkjet marking device. The dryer component includes a first dryer module, the first dryer module includes a rotating first roll and a biasing member. The first roll and the biasing member together define a nip through which the print media passes. An exterior surface of the first roll applies heat directly to the ink images to dry the ink images, at least partially.

### BACKGROUND

The exemplary embodiment relates to ink jet printing and finds particular application in connection with a dryer module for drying printed sheets which utilizes pressure as well as heat.

Inkjet printers eject liquid ink from one or more printheads directly onto a print medium or “substrate,” such as paper, or indirectly, via an intermediate transfer surface, to form images. The printheads each include an array of inkjets, which are selectively actuated to provide a droplet of ink, which is directly or indirectly deposited on the print medium. Each ink generally includes a pigment, such as a cyan, magenta, yellow or black pigment, and a liquid carrier, in which the pigment is dispersed. The liquid carrier may include water and/or an organic liquid or liquids. For example, aqueous inks typically include at least 40% water, by weight, and lesser amounts of one or more organic liquids, such as low molecular weight alcohols or polyols. The liquid carrier is driven from the substrate with a dryer, positioned downstream of the printheads. Current methods for drying use high powered infrared lamps to dry the ink. These devices are generally energy intensive, have a large footprint, and produce a significant amount of excess heat. A high velocity air handling system may be needed to remove the waste heat from the dryer and release it to the atmosphere. Additionally, the paper tends to curl due to moisture being driven out of the paper and the ink layer. After drying, the temperature of the substrate may be reduced in a cooling component, to facilitate printing on the second side of the sheet and to allow handling of the final output without safety implications, which uses additional energy.

There remains a need for an improved dryer system which reduces energy consumption while maintaining or improving image quality.

### BRIEF DESCRIPTION

In accordance with one aspect of the exemplary embodiment, a printing system includes a source of print media, an inkjet marking device which applies ink images to the print media, and a dryer component which receives print media from the inkjet marking device. The dryer component includes at least a first dryer module. The first dryer module includes a rotating first roll and a biasing member. The first roll and the biasing member together define a nip through which the print media passes. An external surface of the first roll applies heat directly to the ink images to dry the ink images, at least partially.

In accordance with another aspect of the exemplary embodiment, a method of printing includes forming a wet ink image on print media by applying droplets of one or more inks to the print media and applying heat to the wet ink image, including directly contacting the wet ink image with a rotating heated pressure roll.

In accordance with another aspect of the exemplary embodiment, a printing system includes an inkjet marking device which applies aqueous ink images to print media and a heated pressure roll assembly which receives the print media from the inkjet marking device. The heated pressure roll assembly includes first and second counter-rotating rolls which together define a nip through which the print media passes. An exterior surface of the first roll applies heat directly to the ink images to dry the ink images at least partially. An exterior surface of the first counter-rotating roll is maintained at a higher temperature than the exterior surface of the second roll.

### BRIEF DESCRIPTION OF THE DRAWINGS

FIG. 1 is a functional block diagram of an inkjet printing system in accordance with one aspect of the exemplary embodiment;

FIG. 2 is a side sectional view of a first dryer module suited to use in the printing system of FIG. 1, in accordance with one aspect of the exemplary embodiment;

FIG. 3 is a side sectional view of a first dryer module suited to use in the printing system of FIG. 1, in accordance with another aspect of the exemplary embodiment; and

FIG. 4 is a flow chart illustrating a method of printing system in accordance with another aspect of the exemplary embodiment.

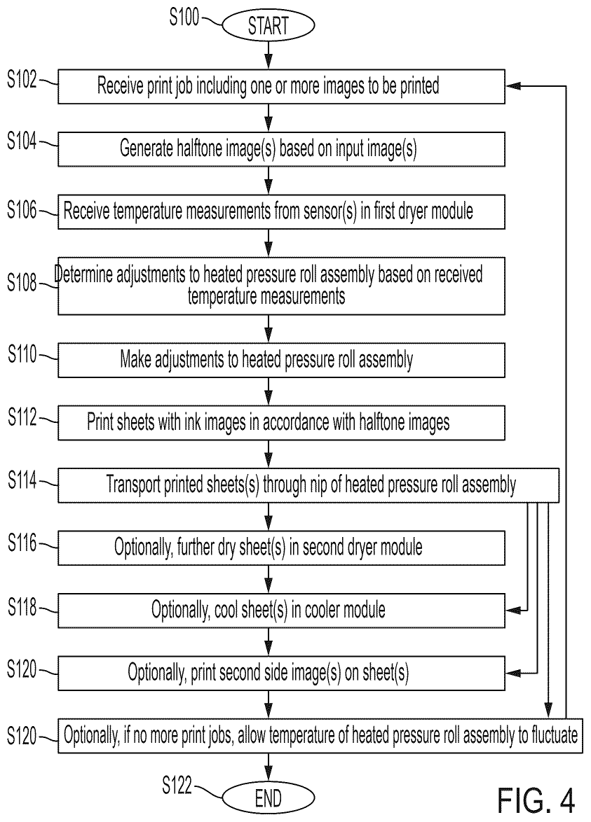

### DETAILED DESCRIPTION

An inkjet printing system and method of printing are described which utilize a heated pressure roll assembly to dry an ink image onto a print media substrate, such as paper. The heated pressure roll assembly is used to directly heat the paper to a temperature that will enhance evaporation of water and cosolvents from the ink and pin the image to the paper.

The heated pressure roll assembly may be employed in combination with, or as an alternative to, a conventional dryer, such as a radiant dryer. The use of the heated roll assembly can result in a decrease in the overall cost of the printing system, since it reduces the need for a primary or secondary dryer. Additionally, the running costs of the printing system can be lower as there tends to be less wastage of heat. Despite direct contact of a wet aqueous ink with the heated pressure roll, the printing system can output clear prints, without smudges. This is due, at least in part, to the hydrophobic nature of the surface of the pressure roll and/or a liquid release agent that is applied to the surface.

As used herein, a printing device can include any device for rendering an image on print media, such as a copier, laser printer, bookmaking machine, facsimile machine, or a multifunction machine (which includes one or more functions such as scanning, printing, archiving, emailing, and faxing). “Print media” can be a usually flimsy physical sheet of paper, plastic, or other suitable physical print media substrate for images. A “document” is normally a set of related sheets, usually one or more collated copy sets copied from a set of original print job sheets or electronic document page images, from a particular user, or otherwise related.

An “aqueous ink” refers to an ink comprising a pigment or dye and a liquid carrier, the liquid carrier including at least 40 wt. %, or at least 50 wt. % water. The liquid carrier may be up to 90 wt. % water, or up to 80 wt. % water, or up to 70 wt. % water, or up to 60 wt. % water. In addition to water, the liquid carrier may include, in total, up to 60 wt. %, or up to 50 wt. %, or up to 40 wt. % of one or more water-soluble or water-miscible organic compounds. Example organic compounds include aliphatic alcohols, such as C2 to C18 monoalcohols, C2 to C18 polyols, C2 to C18 ethoxy alcohols, and mixtures thereof. Example alcohols include 1,3-propanediol, 1,2-butanediol, 1,3-butanediol, 1,4-butanediol, ethylene glycol, diethylene glycol, triethylene glycol, tripropylene glycol, glycerol, diglycerol, polyglycerol, 1,2,4-butanetriol, 1,2,6-hexanetriol, 1,2,5-pentanetriol, 1-methoxy-2-propanol, 2-(2-butoxyethoxy)ethanol, polyethylene glycol monoalkyl ethers, and mixtures thereof. The pigment or dye may be present in the aqueous ink at from 1-10 wt. %. The aqueous ink may be a liquid at room temperature (15-25° C.).

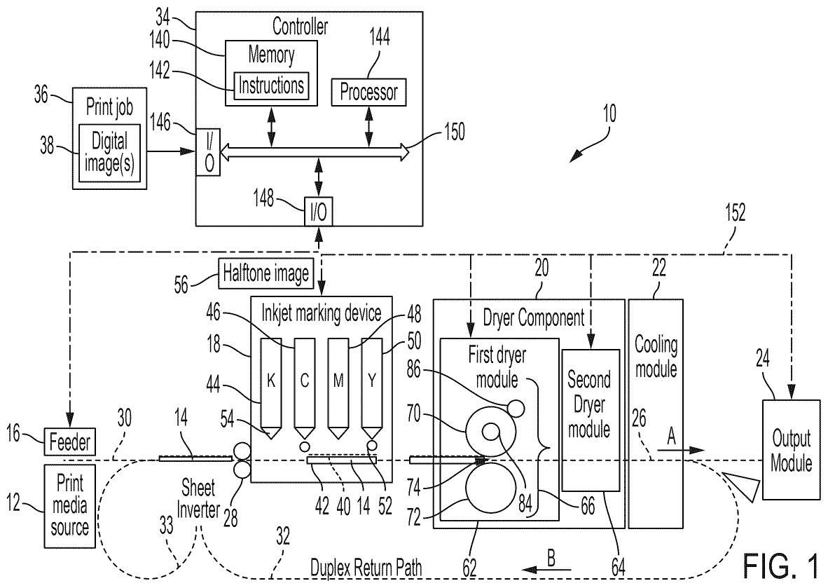

With reference to FIG. 1, an illustrative inkjet printing device 10 includes a source 12 of print media, such as sheets 14 or a continuous web of paper, a print media feeder 16, at least one inkjet marking device 18, a print media dryer component 20, for drying the printed media, optionally a cooling module 22, for cooling the dried media, and an output module 24, such as one or more output trays, all connected by a print media path 26. A print media transport system 28 conveys the print media, e.g., sheets, along the print media path 26, downstream from the feeder 16, and ultimately to the output module 24. The transport system may include one or more of rollers, conveyor belts, air jets, and the like. The print media path 26 may be a simplex path or a duplex path having a main path 30, which transports print media in the direction of arrow A, and a return loop 32, along which the print media returns to the marking device 18 in the direction of arrow B, via a sheet inverter 33.

A controller 34 controls the operation of some or all of the components 16, 18, 20, 22, 24, and 28 of the printing device 10. In particular, the controller receives a print job or document 36 including one or more input images 38 and provides printing instructions to the marking device 18 for rendering each input image as a printed image (or images) 40 on an image receiving surface 42 of the print media 14 using one or more of the inks. This may include converting the input image from contone values to halftone values, which determine whether a drop is printed or not. The controller may receive feedback from one or more of the components 16, 18, 20, 22, 24, and 28 of the printing device 10. For example, the controller may receive temperature measurements from the dryer component 20 and control the dryer component 20 with the goal of drying each printed sheet appropriately.

Each input image 38 may include one or more of text, graphics, photographic images, and the like, in electronic form. In addition to the digital images 38, the print job 36 may also include print job parameters that identify one or more of the print media weight, print media dimensions, print speed, print media type, ink area coverage, location of the image to be produced on each side of each sheet, media color, media fiber orientation for fibrous media, print zone temperature and humidity, media moisture content, and media manufacturer.

The illustrated inkjet marking device 18 includes one or more printheads 44, 46, 48, 50, which are generally spaced in a process direction. As used herein, the term “process direction” means the direction of movement of the surface of the print media as it passes the printheads in the marking device and the term “cross-process direction” means a direction that is perpendicular to the process direction in the plane of the print media surface.

Each printhead 44, 46, 48, 50 typically ejects a single color of ink. The inks used are commonly cyan, magenta, yellow and black, referred to as C, M, Y, and K respectively. The illustrated printheads may eject droplets 52 of one of the inks, in liquid form, directly onto the image-receiving surface 42 of one of the sheets 14 of print media to form the printed image 40, as illustrated in FIG. 1. Alternatively, each printhead ejects ink onto an intermediate transfer member, such as a belt or drum (not shown) from which the formed image is transferred to the print media 14.

The printheads 44, 46, 48, 50 typically each include an array of individual inkjets (nozzles) 54 through which the drops of ink are ejected across an open gap to the sheet surface to form an ink image 40 during printing. In an inkjet printhead, individual piezoelectric, thermal, or acoustic actuators generate mechanical forces that expel the ink through each nozzle, in a faceplate of the printhead. The actuators expel an ink drop in response to an electrical signal. The locations where the ink drops land are sometimes called “ink drop locations,” “ink drop positions,” or “pixels. ” The electrical signals are generated in response to a halftone image 56 that is generated by the controller 34, based on the input image 38.

Each printhead 44, 46, 48, 50 may include one or more rows of inkjets 60, arranged in the cross-process direction. When more than one row is used, the nozzles in one row may be offset from those in another row to increase the number of pixels (dots) per inch which can be achieved in the printed image 40.

As will be appreciated, the input image 38 may undergo one or more preprocessing steps prior to generation of a halftone image. Such preprocessing steps are known in the art and may include conversion of the input image from a device-independent color space (e.g., RGB) to a device-dependent color space (e.g., CMYK), correction of skew (particularly in the case of text documents), changing, e.g., reducing the pixel resolution, rescaling the contone values, and the like. For ease of reference, the term “input image” is used to refer to the contone image 38 before and after any preprocessing.

The print media dryer component 20 includes at least a first dryer module 62. The print media dryer component 20 optionally includes one or more additional, or second dryer modules 64, located in the paper path, upstream and/or downstream of the first dryer module 62. In the illustrative printing system shown in FIG. 1, the print media dryer component 20 includes a radiant dryer module 64, positioned downstream of the first dryer module 62 to provide additional drying, if needed, to the printed and at least partially dried image 40. However, such a dryer module 64 could additionally or alternatively be positioned upstream of the first dryer module. In another embodiment, the first dryer module 62 is the only dryer module, no additional drying is performed.

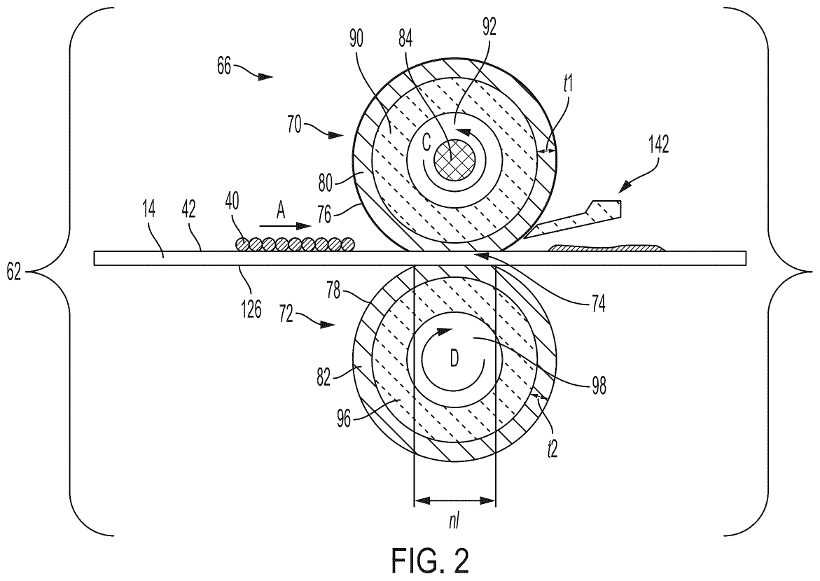

With reference also to FIG. 2, in one embodiment, the first dryer module 62 includes a heated pressure roll assembly 66, which includes a first pressure roll 70 and a biasing member 72, such as a second roll, as shown, or a plate. The illustrated embodiment includes counter-rotating first and second rolls 70, 72, which rotate about parallel central axes that are horizontally aligned with the cross-process direction. Roll 70 and member 72 together define a nip 74 therebetween. The pressure applied to the sheet in the nip 74 may be in a range of 1 KPa to 5000 Kpa, or at least 100 Kpa, or at least 500 Kpa. The pressure roll assembly may be configured to provide a variable nip in terms of the distance between the rolls 70, 72. This allows the pressure roll assembly 66 to accommodate various paper thicknesses. For example, one or both of the rolls 70, 72 may be moveable in a plane perpendicular to the sheet to adjust a height of the nip. Alternatively, or additionally, one or both of the rolls 70, 72 may be replaceable with a different roll which provides a different nip height and/or nip pressure (e.g., using a softer or harder material and /r different thickness of material).

In the embodiment of FIG. 2, both rolls 70, 72 have a conformable outer surface 76, 78, which is defined by a respective outer layer 80, 82 formed of a conformable material. In other embodiments, the layer of conformable material is omitted on one or both of the rolls 70, 72.

In the embodiments described herein, the outermost layer 80 of the pressure roll 70 may be formed from a thin layer of a hydrophobic material, such as polytetrafluoroethylene (PTFE), commonly sold as Teflon®, or polyfluoroacrylate (PFA), to act as a release layer for the hydrophilic ink. Other suitable materials include silicone polymers and ceramic materials that are hydrophobic. Hydrophobic materials generally have an intrinsic contact angle between a droplet of water and a horizontal surface of the material of at least 90°, or at least 100°, or at least 110°, as measured with a goniometer.

Other materials which can be used for the outermost layer(s) 80, 82 include other fluorinated polymers (i.e., fluoropolymers), thermoelastomers, resins, thermosetting polymers or other cross-linked materials. Examples of fluoropolymers include fluoroelastomers (e.g., VITON® fluoroelastomers from Chemours, DYNEON™ fluoroelastomers from 3M Company), polyperfluoroether elastomers, fluorinated thermoplastics including fluorinated polyethers, fluorinated polyimides, fluorinated polyetherketones, fluorinated polyamides, fluorinated polyesters, and synthetic or natural rubber. The polymer may be formed with or without a crosslinking agent.

In one embodiment, particles may be dispersed in the polymer of the outer layer 80, which provide an uneven surface to aid in release of the printed sheets. For example, silsesquioxane-based particles and/or carbon nanotubes may be dispersed in the polymer, as described, for example in U.S. Pat. No. 8,710,137 B2 to Moorlag, et al. The silsesquioxane-based particles can be nanosized, e.g., having a size range of about 1000 nm (1 micron) or less, such as 0.5 nm to 5 nm, or 1 nm to 2 nm.

A thickness t1, t2 of the outer layer(s) 80, 82, where present, may be at least 0.02 mm and/or up to 2 mm, or up to 1 mm. Different materials may have different conformability levels, and/or other features which may have a bearing on an optimal thickness(es) t1, t2. For example, an exemplary PTFE layer 80 may have a thickness of 0.02 mm to 0.08 mm. An exemplary PFA layer 80 may have a thickness of 0.03 mm to 0.15 mm. In one embodiment, the outer layer 80 may include a PFA sleeve over a layer of different elastomer, such as PTFE, having a combined thickness of, for example, 0.02 mm to 2 mm, or up to 1 mm.

A length nlof the nip 74 in the process direction A is influenced, at least in part, by the applied pressure and the conformability of the outer surface 76, 78 of each of the rolls 70, 72. Other factors which may influence the nip length nlmay include a diameter of the roll(s) and the respective thickness t1, t2 of the outer layer(s) 80, 82. A dwell time the time period during which the heat and pressure is applied) of the sheet within the nip 74 is determined by the nip length nland a speed of the sheet 14 in the process direction A. The amount of heat transferred to the sheet is a function of the dwell time, as well as a temperature of the surface(s) 76, 78 and type of print media 14.

At least one of the first and second pressure rolls 70, 72 is heated. In the embodiment of FIG. 2, only the first pressure roll 70 is heated. The roll(s) may be heated by an internal and/or external heater. For example, in the embodiment of FIG. 2, an internal heater 84 raises a temperature of the outer surface 76 above ambient temperature. As the print media 14 with a wet ink image 40 thereon enters the nip 74, heat from the heated pressure roll 70 causes at least some of the liquid carrier to evaporate from the ink. Moisture from the print media 14 may also be driven off. By providing a direct contact of the heated roll 70 with the substrate 14, and applying pressure, thermal transfer to the substrate and ink occurs by conduction.

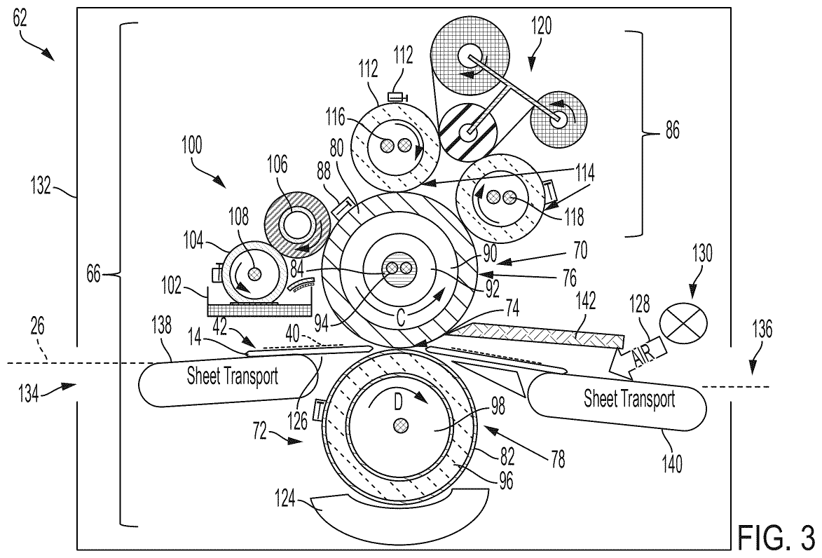

With reference to FIG. 3, another embodiment of a first dryer module 62 is illustrated. The dryer module in this embodiment can be configured as for the embodiment of FIG. 2, except as noted. Similar elements are accorded the same numerals. As will be appreciated, features of the two embodiments may be combined.

As for the embodiment of FIG. 2, the heated pressure roll assembly 66 of the first dryer module 62 includes counter-rotating first and second rolls 70, 72, which rotate about parallel central axes that are horizontally aligned with the cross-process direction. In this embodiment, the first roll 70 is heated by both an internal heater 84 and an external heater 86 to maintain the exterior surface 76 of the heated roll 70 at a selected temperature for drying the ink image 40. The surface temperature tends to fluctuate due to heat withdrawn from the roll 70 as each sheet passes through the nip 74. Having both internal and external heaters 84, 86 can assist in reducing the temperature variation. A temperature sensor 88, such as a thermistor, thermocouple, or thermopile, is positioned adjacent to the exterior surface 76 to detect the temperature of the surface 76. Temperature-based measurements (e.g., in terms of electrical resistance) are collected by the temperature sensor 88 (and other heat sensors, where present) and sent to the controller 34. The controller determines suitable adjustments to one or more of the heaters 84, 86 to maintain an output temperature of the dried sheet within a suitable range, such as 80 - 100° C. For example, the surface 76 of heated roll 70 is maintained at a temperature of 80 - 100° C., in the nip 74, such that the ink does not exceed its flashpoint, which is generally greater than 100° C. for aqueous inks.

In the first dryer module 62 illustrated in FIGS. 2 and 3, the heated first roll 70 includes a cylindrical drum formed from one or more concentric layers 80, 90. In the illustrated embodiment, the outer layer 80 surrounds and spaces the inner layer 90 from the outer surface 76 of the drum. The outer layer 80 may be bonded to or otherwise be adhered to the inner layer 90. In other embodiments, one or more additional layers (not shown) may space the outer layer from the inner layer.

In one embodiment, the innermost (or only) layer 90 defines a hollow core 92 in which the heater 84 is axially located. The heater 84 may include one or more heating elements 94, such as electrical resistance heaters (two in the illustrated embodiment). In one embodiment, the heat output by the heater 84 can be varied, for example by switching one or more of the heating elements 94 on or off and/or by varying an electrical current supplied to the heating elements. In another embodiment, the heat output by the heater 84 is maintained at a constant level, with only the external heater 86 being adjusted to control the temperature of the surface 76.

The layer 80, where present, may serve as a conformable layer to distribute the applied pressure over a wider area in the nip. The inner layer 90, where present, may be formed from a thermally-conductive metal or alloy, such as steel or aluminum, or a ceramic material, and may have a wall thickness greater than that of the outer layer 80. Roll 72 may be similarly configured with respective inner and outer layers 96, 82 and optionally a hollow core 98.

The second counter-rotating roll 72 may be formed from the same or different materials to the roll 70. In one embodiment, the outer layer 82 may be formed from a conformable material, such as rubber, and the inner layer 96 formed from a harder material than the conformable material, such as a metal or alloy, e.g., aluminum or steel. In another embodiment, the roll 72 may be formed without a conformable layer, e.g., a single layer of metal or alloy.

In one embodiment, a liquid release agent is applied to the surface 76 of the roll 70 to make it more hydrophobic. In this embodiment, a less hydrophobic material may be used for the outer (or only) layer 80 of the drum. In one embodiment, where a liquid release agent is used, the outer layer 80 is omitted. For example, the drum may be formed of a bare metal or alloy, such as steel or aluminum, or a ceramic material, such as aluminum nitride or silicon carbide.

The term release agent generally refers to any type of liquid that may be applied to the roll 70 to improve the release of inks from the surface. Example release agents include hydrocarbon-based oils, such as a mineral oils and vegetable oils, silicone-based oils, and the like. For example, silicon-based oils, which may be blended or reacted with a small amount of an amine (e.g., 0.1-2 wt. % amine, or about 0.5 wt. % amine) may be used. Such oils may have a kinematic viscosity in the range of 20-150 cSt at 25° C. and atmospheric pressure. Examples include polydimethylsiloxane oils that are functionalized with aminoalkyl groups. Other release agents are described, for example, in U.S. Pub. No. 20130337151 A1, which describes oils and silicone-based products used to prevent ink offset from the substrate to printing equipment.

The release agent may be applied to the surface 76 of the first pressure roll 70 by an oil applicator 100, such as a pad, roller, wick, or the like. In the illustrated embodiment, the applicator includes an oil receptacle 102 containing a supply of the release agent. The release agent is carried from the receptacle 102 by a rotating meter roll 104 and transferred, by contact, from the meter roll to a counter-rotating donor roll 106. The donor roll contacts the surface 76 of the pressure roll 70, allowing the release agent to finely coat the surface 76. The release agent may be heated to assist in spreading the release agent on the roll 70. For example, the meter roll 104 may be heated, e.g., by an internal heating element 108, to raise the temperature of the release agent. As will be appreciated, other types of oil applicators may be readily employed. When a sheet enters the nip 74, some of the release agent is transferred onto the image-receiving surface 42 of the printed sheet.

One additional advantage of using a release agent is that the release agent generally leaves a smooth, glossy, uniform finish on the paper 14. This helps to inhibit gloss differential defects, which can be observed in conventional inkjet prints.

Another advantage is that the release agent also enables cheaper uncoated paper to have the appearance of an expensive, coated paper.

The external heater 86, where present, may include one or more external heat rolls 112, 114 (two in the illustrated embodiment), which contact the outer surface 76 of the pressure roll 70. The external heat roll(s) 112, 114 may be heated by respective internal heating elements 116, 118, in a similar manner to the roll 70. The external heat roll(s) 112, 114 may be driven by a common drive mechanism 120, as illustrated, or by respective drive mechanisms. The illustrated drive mechanism includes a driven roller which contacts and drives both heat roll(s) 112, 114. A temperature of the surfaces of the external rolls 112, 114 may be monitored by one or more sensors 122, as for the first roll 70.

A drive mechanism (not shown) causes the pressure roll 70 to rotate in the direction of arrow C at a speed and in a direction which matches that of the incoming sheet in order to minimize relative motion between the inked sheet surface and the roll surface 76. A similar drive mechanism (not shown) causes the second roll 72 to rotate in the direction of arrow D at a speed and in a direction which matches that of the incoming sheet in order to minimize relative motion between the uninked sheet surface and the exterior surface 78 of the roll 72. One or both of the drive mechanisms also causes the associated roll to apply pressure to the other roll, providing a pressure which keeps the printed surface 42 of the print media in contact with the surface 76 as the sheet passes through the nip 74.

In one embodiment, the exterior surface 78 of the second roll 72 may be maintained, during operation at a lower temperature than the exterior surface 76 of the first roll 70. For example, the first roll exterior surface 76 may be at least 10° C. higher, at the nip, than the second roll exterior surface 78. The surface 78 of the second roll 72 may be cooled by a suitable cooling mechanism 124. The cooled roll 72 cools a second surface 126 of each sheet 14 as the sheet is carried through the nip 74. As a result, less moisture is driven from the sheet by the heated first roll 70 and the sheet cools more quickly as it leaves the nip. Suitable cooling mechanisms 124 include cooling pipes or blocks that may be chilled by a refrigerant. The cooling mechanism 124 may be spaced from the surface 78 of the second roll by a narrow gap. Alternatively, or additionally, the dried sheets may be contacted by a flow of optionally cooled air 128, after leaving the nip 74. The flow of air entrains the vapor released from the sheet and carries it away. The air flow 128 may be provided by a cooling mechanism 130, such as a fan, pump, or the like. Suitable ductwork (not shown) may connect the cooling mechanism and/or the airflow with an exterior of the dryer component 20.

In another embodiment, the second roll 72 may be heated in a similar manner to the first roll 70, e.g., with internal and/or external heaters.

The first dryer module 62 may include a housing 132 which surrounds the heated pressure roll assembly 66. In operation, the printed sheets are carried along the paper path through inlet and outlet slots 134, 136 in the housing 132. In the illustrated embodiment, the sheet transport system includes first and second sheet transports 138, 140, e.g., conveyor belts, which transport the sheets towards and away from the nip 74, respectively. A sheet peeler 142 helps to direct the dried sheet onto the second transport 140.

In one embodiment, the housing 132 may also surround a second heated pressure roll assembly, downstream of the heated pressure roll assembly 66, and configured in a similar manner to provide additional drying to the ink image.

Returning to FIG. 1, the second dryer module 64, where present, may employ the same or a different heating method to the first dryer module 62. In one embodiment, the second dryer module 64 includes a radiant near infrared (NIR) heater such as a set of infrared carbon lamps, a forced hot air convection heater, a set of laser diodes, or the like for removing water and/or organic solvents from the partially-dried images 40. In practice, the second dryer module 64 may not be needed, since one heated pressure roll assembly 66 is expected to be able to replace two conventional dryer modules.

The dried sheets may be conveyed from the dryer component 20 to a cooling module 22. The cooling module serves to reduce the temperature of the heated sheets to a suitable temperature for inputting to the marking engine 18, (or to a second marking engine (not shown), which may be located in the paper path, downstream of the cooling module). In one embodiment, the cooling module 22 removes excess heat from the paper with a cooling drum. The heat transfers via conduction from the paper to the drum surface, which is typically made of aluminum, and then via convection to air that is flowing through the center of the drum and exhausted from an outlet. U.S. Pub. Nos. 20140198164 A1 and 20150220052 A1 describe exemplary cooling drums which may be used. Other types of cooling devices are known, including multi-sheet cooling buffers, as described, for example, in U.S. Pub. No. 20230286305 A1.

In practice, the cooling module 22, if used, may be a relatively simple device, of a lower cost design than conventionally required, since some of the heat absorbed by the sheet can be removed by the airflow 128 and/or by a cooled second roll 72. In another embodiment, the sheet cools by passive cooling, e.g., in an output tray of the output device 24.

As illustrated in FIG. 1, the exemplary controller 34 includes memory 140 storing software instructions 142 for controlling components of the printing system, specifically the dryer component 20. The controller 34 may include one or more input/output devices 144, 146 for communicating with external devices, such as a source of the print job 36 and the printing device components 16, 18, 20, 22, 24, and 28. Hardware components 140, 144, 146, 148 of the controller 34 may communicate via a data/control bus 150. The controller may communicate with other components 16, 18, 20, 22, 24, and 28 of the printing system via wired or wireless links 152 to provide printing instructions to the other components and receive data, such as temperature measurements, from the other components.

With reference to FIG. 3, a method of printing, which can be performed with the printing system 10 of FIG. 1, and 2 or 3 is illustrated. The method begins at S100.

At S102, a print job 36 including one or more input images 38 to be printed is received by the controller 34 and may be temporarily stored in memory 140.

At S104, one or more halftone images 56, or other images in printable form, are generated from the input image(s) 38 by the controller.

At S106, temperature measurements are received from the temperature sensors 88, 112, etc., in the dryer component 20.

At S108, adjustments to the heated pressure roll assembly 66, in particular, heating elements 94, 108, 116, 118, may be computed, by the controller 34, based on the received temperature measurements. The adjustments may be computed to achieve a desired temperature of the rolls 70, 72, 96, 102, 104 and may be dependent, to some degree, on one or more printing parameters, such as the print media weight, ink coverage, print speed, ambient temperature and humidity, and the like.

At S110, the computed adjustments may be sent to the dryer component 20 by the controller 34. The heating elements 94, 108, 116, 118, etc. are adjusted accordingly. Steps S106, S108, and S110 may be repeated throughout the printing of the print job to ensure that all the sheets are dried equivalently.

At S112, sheets are printed by the marking engine 18 in accordance with the halftone image(s) 56.

At S114, the printed sheets 14 with the wet ink images 40 thereon are transported to the dryer component 20 and enter the nip 74 of the first drier module 62 where the ink image 40 contacts the outer surface 76 of the heated roll 70, drying the ink image and transferring release agent, where used, to the ink image 40 and paper surface 42 in the process. Airflow may be added after the nip to evacuate the vapors released from the sheet.

At S116, the dried sheets are optionally further dried in a second, or subsequent dryer module 64, where present.

At S118, the dried sheets are optionally transported to and cooled in the cooling module 22, where present.

At S120, the dried sheets 14 may be directed along the duplex path 32, via the inverter 33, back to the marking engine 18, for printing on the second side 126 of each sheet. Alternatively, the dried sheets 14 may be directed to a second marking engine (not shown), downstream of the dryer component 20 and cooling module 22, where present. In simplex printing systems, or when the printing device is being used for simplex (single sided) printing, however, the dried sheets 14 may be directed from the cooling module 22 to the output module 24.

At S122, when the print job is complete, and there are no new print jobs ready to be processed by the printing system, the controller may instruct the dryer component 20 to go into a sleep mode until the next print job is received. In the sleep mode, the temperature of the heated roll 70 may be allowed to deviate from the temperature used in printing. Initially, the temperature of the heated roll may increase, due to the absence of sheets drawing heat away in the nip 74. Subsequently, the temperature of the heated roll may drop, if the heaters 84, 86, etc. are switched off or otherwise have their operating temperatures reduced. When a new print job 36 is received for printing (S102), the controller again instructs the dryer component 20 to raise or lower the temperature of the drum surface 76, based on feedback from the sensors 88, 112, etc., at S106.

The method ends at S124.

The exemplary controller 34 thus controls the operation of some or all of the components 16, 18, 20, 22, 24, and 28 of the printing device 10 to form one or more images on sheets of print media with the marking device 18, dry the printed sheets with the dryer component 20, cool the dried sheets with the cooling module 22, where present, and transport the sheets between the components and ultimately to the output device 24. As will be appreciated, some functions of the controller may be delegated to controllers (not shown) in the other components 16, 18, 20, 22, 24, and 28 of the printing system 10.

The controller 34 may include one or more computing devices, such as a dedicated computing device, PC, laptop, or palmtop computer, portable digital assistant (PDA), server computer, cellular telephone, tablet computer, pager, combination thereof, or other computing device capable of executing instructions for performing the exemplary method.

The memory 140 may represent any type of non-transitory computer readable medium such as random access memory (RAM), read only memory (ROM), magnetic disk or tape, optical disk, flash memory, or holographic memory. In one embodiment, the memory 140 comprises a combination of random access memory and read only memory. In some embodiments, the digital processor 144 and memory 140 may be combined in a single chip. Memory 140 stores instructions 142 for performing the exemplary method as well as the processed data.

The network interface 146 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 144 can be variously embodied, such as by a single-core processor, a dual-core processor (or more generally by a multiple-core processor), a digital processor and cooperating math coprocessor, a digital controller, or the like. The digital processor 144, in addition to executing instructions 142 may also control the operation of the controller 34.

The term “software instructions,” as used herein, is intended to encompass any collection or set of instructions executable by a computer or other digital system so as to configure the computer or other digital system to perform the task that is the intent of the software. The term “software instructions” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The method illustrated in FIG. 3 may be implemented, at least in part, in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the controller 34 (for example, an internal hard drive of RAM), or may be separate (for example, an external hard drive operatively connected with the controller 34), or may be separate and accessed via a digital data network such as a local area network (LAN) or the Internet (for example, as a redundant array of inexpensive or independent disks (RAID) or other network server storage that is indirectly accessed by the controller 34, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 3, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

In addition to the benefits noted above, the exemplary printing system and method may also provide some or all of the following:

The release agent prevents or inhibits ink from sticking to the rolls.

The release agent has the additional benefit of evenly coating the paper which can visually enhance the output sheets.

One or both of the dryer module(s) 20, 22 can each be a replaceable module, allowing reconfiguration of existing printing systems. Alternatively, or additionally, one or both of the rolls 70, 72 may be replaceable, e.g., by a customer, to accommodate different print media substrates and/or inks.

An exhaust module, if required for the dryer component 20, may operate on a much lower airflow to remove any excess heat and gases.

Less power is needed to transfer heat energy to the paper since it is in direct contact with the heated surface. This also results in less heat waste.

Overall, the present dryer module 62 can be less expensive, less energy intensive, produce less waste heat, and occupy a smaller footprint than a conventional dryer.

To demonstrate the effectiveness of a heated pressure roll assembly 66, wet printed sheets, printed with an inkjet marking device, are passed through a dryer module as illustrated in FIG. 2. A release agent (silicone-based oil) is applied to the heated roll 70 by the applicator 92 and transferred to the sheets at the nip 74. Using a rub test, the image 40 is found to be dry after passing through the nip, as no smearing is observed. The printed image appears visually to be of high quality due to the uniform layer of gloss from mechanical smoothing/ironing in the nip and application of the silicone-based oil. In contrast, a printed image that is not passed through the dryer module shows smears in the rub test.

Each of the references mentioned herein is incorporated herein by reference in its entirety.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A printing system comprising:
a source of print media;
an inkjet marking device which applies ink images to the print media; and
a dryer component which receives print media from the inkjet marking device, the dryer component comprising a first dryer module, the first dryer module comprising a rotating first roll and a biasing member, the first roll and the biasing member together defining a nip through which the print media passes, an exterior surface of the first roll applying heat directly to the ink images to dry the ink images at least partially.

2. The printing system of claim 1, further comprising at least one of an internal heater and an external heater for heating the exterior surface of the first roll.

3. The printing system of claim 2, wherein the exterior surface of the first roll is heated by an internal heater, located within the first roll.

4. The printing system of claim 2, wherein the surface of the first roll is heated by an external heater, adjacent to the exterior surface of the first roll.

5. The printing system of claim 2, further comprising:
a sensor which senses a temperature of the exterior surface of the first roll; and
a controller which controls the at least one of the internal heater and the external heater based on the sensed temperature.

6. The printing system of claim 1, wherein the first roll comprises a drum including first and second layers, the first layer defining the exterior surface of the drum, the second layer being spaced from the exterior surface by the first layer, the first layer being formed from a hydrophobic polymer.

7. The printing system of claim 1, further comprising an applicator which applies a release agent to the surface of the first roll, whereby the release agent is applied to the ink images.

8. The printing system of claim 7, wherein the release agent comprises a silicone-based oil.

9. The printing system of claim 1, wherein the biasing member comprises a counter-rotating second roll.

10. The printing system of claim 1, further comprising a cooling mechanism which cools a surface of the biasing member.

11. The printing system of claim 1, further comprising a cooling device which receives print media that has been heated by the dryer component.

12. The printing system of claim 1, further comprising a transport system which conveys the print media along a paper path which connects the print media source, marking device, dryer component, and a sheet media output module.

13. The printing system of claim 1, wherein the paper path includes a return path which returns dried print media from the dryer component to the marking device.

14. The printing system of claim 1, wherein in applying the ink images, the marking device applies droplets of at least one aqueous ink to the print media.

15. A method of printing comprising:
forming a wet ink image on print media by applying droplets of one or more inks to the print media; and
applying heat to the wet ink image, including directly contacting the wet ink image with a rotating heated pressure roll.

16. The method of claim 15, further comprising:
applying a release agent to the wet ink image with the rotating heated pressure roll.

17. The method of claim 15, wherein the rotating heated pressure roll has a hydrophobic surface which directly contacts the wet ink image.

18. The method of claim 15, further comprising:
after applying heat to the wet ink image, applying an airflow to the ink image.

19. A printing system comprising:
an inkjet marking device which applies aqueous ink images to print media; and
a heated pressure roll assembly which receives the print media from the inkjet marking device, the heated pressure roll assembly comprising first and second counter-rotating rolls which together define a nip through which the print media passes, an exterior surface of the first roll applying heat directly to the ink images to dry the ink images at least partially, the exterior surface of the first counter-rotating roll being maintained at a higher temperature than an exterior surface of the second roll.

20. The printing system of claim 19, further comprising an applicator which applies a hydrophobic release agent to the surface of the first roll, whereby the release agent is applied to the ink image at the nip.
